(19) United States
(12) Patent Application Publication
(10) Pub. No.: US 2002/0123255 A1
(43) Pub. Date: Sep. 5, 2002

(54) Providing a lamp socket cover

(76) Inventor: John Edwin Kertesz, Logan, UT (US)

Correspondence Address: KIRTON AND MCCONKIE, 1800 EAGLE GATE TOWER, 60 EAST SOUTH TEMPLE, P O BOX 45120, SALT LAKE CITY, UT, 84145-0120, US

(21) Appl. No.: 10/091,675

(22) Filed: Mar. 5, 2002

Related U.S. Application Data
(60) Provisional application No. 60/273,260, filed on Mar. 5, 2001.

(51) Int. Cl. H01R 13/44

(52) U.S. Cl. 439/135

(57) ABSTRACT

Systems and methods for selectively covering a lamp socket to prevent exposure of the lamp socket. An apparatus or device is configured to selectively couple with a lamp socket for use as a covering for an otherwise exposed lamp socket. The apparatus is a lamp socket cover that includes a shaft configured to have at least a portion selectively reside in a lamp socket, wherein the shaft includes a top and a bottom and wherein the top of the shaft is coupled to a head. The diameter of the head extends past the diameter of the lamp socket to prevent moisture from entering therein. The socket cover comprises a non-conductive material. Optionally, the socket further includes a conductive material to close an otherwise open electrical circuit.

### RELATED APPLICATIONS

This application claims priority to U.S. Provisional Patent Application Serial No. 60/273,260 filed Mar. 5, 2001, entitled LAMP SOCKET COVER.

### BACKGROUND OF THE INVENTION

1. Field of the Invention

The present invention relates to providing a lamp socket cover. More particularly, the present invention relates to systems and methods for selectively covering a lamp socket to prevent exposure of the lamp socket.

2. Background and Related Art

Artificial light sources are used for a variety of reasons, including to provide illumination and/or decoration. Currently, electric light strands that typically include a plurality of lamp sockets configured to receive a corresponding plurality of electric light sources are available to consumers. The light strands are selectively placed about objects such as trees, bushes, railings, eves, homes, businesses, poles, walls, fireplaces, windows, or any other object located either indoors or outdoors for which a light strand may be coupled thereto or hung from in order to provide illumination and/or decoration.

One such example of the use of a light strand typically occurs during festive occasions or holidays, such as during the Christmas season. The light strands are typically available in predetermined lengths of flexible power cord that include the plurality of sockets and may be selectively coupled to other light strands in either series or parallel.

Typically, the installation or mounting of a light strand includes the coupling or mounting of the strand onto the object. For example, when one or more light strands are to be hung from the eaves of a home, a user typically begins at one end of the eaves and proceeds to the other end of the eaves by using hooks, tape, or another attachment device at sequential intervals and using a series of light strands to satisfy the span of the eaves. This process of hanging light strands is often frustrating to the user since the sum of the light strand lengths rarely corresponds to the actual length of the eaves or to the size of the object on which the strands are being hung. Thus, for example, an excess amount of a light strand typically extends beyond the eaves and includes one or more lamp sockets that are not utilized for the providing of illumination. As such, the user typically removes the electric light sources from the sockets of the excess portion to prevent any illumination therefrom. However, an exposed lamp socket has proven to be hazardous and may affect the entire electrical circuit created by the strand of lights by providing an open circuit.

To prevent the exposure of an unused lamp socket, a variety of techniques have been utilized. One such technique includes coupling a “burned-out” light source or bulb to each corresponding socket of the excess portion. While this technique prevents the exposure of the-empty lamp sockets, this technique provides confusion to the user as to how the light strands were hung previously since the user typically does not know which electric light sources provide illumination and which don't without plugging the light strand into an electric socket. In other words, this technique does not provide a point of reference for hanging the light strand up in a similar fashion as to how it had been done previously.

Another technique for preventing an exposed lamp socket includes using adhesive tape, such as electrician's tape or duct tape, over the opening of the lamp socket. While this technique prevents the exposure of the lamp socket, it can allow for the entry of moisture into the lamp socket, thereby coming in contact with the electrical circuit of the light strand.

Another technique used to prevent an exposed lamp socket of the light strand includes cutting the light strand to the exact length desired. While this technique prevents the exposure of an unused lamp socket, it can impact the quality and safety of the use of the light strand compared with not modifying what the original manufacturer had designed, produced, and tested in line with electrical standards. Furthermore, once a light strand has been cut to a particular length, it is difficult to change the position of a light strand for future use to create other designs, or to appropriately fit another object having different dimensions.

Thus, while techniques currently exist that are used to prevent exposure of an unused socket, challenges still exist, including preventing moisture from entering into the unused socket, affecting the design of a light strand, providing an indication as to how the light strand was hung previously, and other such challenges. Accordingly, it would be an improvement in the art to augment or even replace current techniques with other techniques.

### SUMMARY OF THE INVENTION

The present invention relates to providing a lamp socket cover. More particularly, the present invention relates to systems and methods for selectively covering a lamp socket to prevent exposure of the lamp socket.

Implementation of the present invention takes place in association with an apparatus or device that is configured to be selectively coupled to a lamp socket, and used as a covering for the otherwise exposed lamp socket. In one implementation, the apparatus is a lamp socket cover that includes a shaft configured to couple to the lamp socket, wherein the shaft includes a top and a bottom and wherein the top of the shaft is coupled to a head. The diameter of the head extends past the diameter of the lamp socket to prevent moisture from entering into the lamp socket.

Implementations of the present invention enable the insertion of the shaft into the lamp socket and the coupling thereto in a variety of manners. For example, in one implementation, a lamp socket cover includes a threaded shaft that corresponds to the threads of a lamp socket to allow the lamp socket cover to be selectively screwed into or out of the lamp socket. In another implementation, the lamp socket cover comprises a pliable plastic or rubber material that allows the lamp socket cover to be selectively pushed into the lamp socket, using friction to maintain the inserted portion of the lamp socket cover in the lamp socket. In another implementation, a groove or channel is located in the underneath portion of the lamp socket cover head and is configured to selectively receive an upper rim of a lamp socket. One implementation embraces an apparatus that comprises a non-conductive material to prevent the exposure of an otherwise unused lamp socket. Another implementation includes a conductive material to close an otherwise open electrical circuit.

While the methods and processes of the present invention have proven to be particularly useful in association with light strands used for decorating purposes, those skilled in the art can appreciate that the methods and processes can be used in a variety of different applications and in a variety of different areas of manufacture to prevent the exposure of an unused light socket.

These and other features and advantages of the present invention will be set forth or will become more fully apparent in the description that follows and in the appended claims. The features and advantages may be realized and obtained by means of the instruments and combinations particularly pointed out in the appended claims. Furthermore, the features and advantages of the invention may be learned by the practice of the invention or will be obvious from the description, as set forth hereinafter.

### BRIEF DESCRIPTION OF THE DRAWINGS

In order that the manner in which the above recited and other features and advantages of the present invention are obtained, a more particular description of the invention will be rendered by reference to specific embodiments thereof, which are illustrated in the appended drawings. Understanding that the drawings depict only typical embodiments of the present invention and are not, therefore, to be considered as limiting the scope of the invention, the present invention will be described and explained with additional specificity and detail through the use of the accompanying drawings in which:

FIG. 1 illustrates a representative system that prevents the exposure of an otherwise unused lamp socket;

FIG. 2 provides a perspective view of one embodiment of the present invention that is threaded to selectively screw into a lamp socket to prevent the exposure of the lamp socket;

FIG. 3 provides a perspective view of another embodiment of the present invention that is selectively pushed into a lamp socket to prevent the exposure of the lamp socket;

FIG. 4 provides a perspective view of an embodiment of the present invention that prevents the exposure of a lamp socket and includes a conductive material to close an otherwise open electrical circuit; and

FIG. 5 illustrates another representative system that prevents the exposure of an otherwise unused lamp socket.

### DETAILED DESCRIPTION OF THE INVENTION

The present invention relates to providing a lamp socket cover. More particularly, the present invention relates to systems and methods for selectively covering a lamp socket to prevent exposure of the lamp socket.

In the disclosure and in the claims the term “lamp” shall refer to a light bulb or other light source that is configured to provide illumination. Accordingly, in the disclosure and in the claims, the term “lamp socket” shall refer to an aperture or opening configured to receive a lamp and to provide an electrical connection to enable illumination of the lamp.

Embodiments of the present invention embrace the use of a non-conductive material that is selectively formed, molded, or otherwise manufactured to correspond or couple with a lamp socket to prevent the lamp socket from being otherwise exposed. Such non-conductive materials that may be used in accordance with the present invention include polymers, such as polypropylene, high-density polyethylene, low-density polyethylene, high-impact polystyrene, Acrylonitrile Butadiene Styrene (“ABS”), polyethylene terephthalate (“PET”), and other non-conductive polymers, rubber materials, such as a pliable rubber, or any other material that does not conduct electricity. Optionally, as will be further discussed below, embodiments of the present invention include the use of a conductive material to prevent an otherwise open electrical circuit.

Embodiments of the present invention further embrace a variety of apparatuses having a variety of shapes, designs, colors, and/or configurations, wherein each apparatus includes means configured for selective insertion of at least a portion of the apparatus into a lamp socket and means for selectively coupling the apparatus to the lamp socket. Examples of means for selective insertion into a lamp socket include a shaft, a wedge, a hollow cylinder, a solid cylinder, or any other configuration or shape that may be selectively inserted into a lamp socket. Since lamp sockets are available in a variety of sizes, and diameters, those skilled in the art will appreciate that the embodiments of the present invention embrace a variety of different diameters to correspond the variety of lamp sockets that are available. Examples of means for selectively coupling the apparatus to a lamp socket include threads, friction, detent connections, raised surfaces, and other configurations or devices that may be used to secure a non-conductive material within the lamp socket, including an adhesive material. Optionally, an apparatus configured to selectively cover a lamp socket includes means for gripping the apparatus. Examples of means for gripping include a roughened surface, an aperture configured to receive a tool that may be used to selectively insert or remove a lamp socket cover form a lamp socket, one or more ridges, and the like.

With reference to FIG. 1, a representative embodiment is illustrated that includes lamp socket cover 10, which is configured to selectively couple with lamp socket 20. In one embodiment, lamp socket 20 is a lamp socket of a light strand that is unused or from which illumination is not desired. Lamp socket cover 10 includes head 12 coupled to shaft 14. Furthermore, in the illustrated embodiment, head 12 includes grip 16, which facilitates a user 24 in coupling socket cover 10 to socket 20 or removing cover 10 from socket 20.

In the illustrated embodiment, shaft 14 includes threads 18, which are an example of means for coupling socket cover 10 to socket 20. In the illustrated embodiment, the threads 18 are outer threads that correspond to inner threads 22 of socket 20 so as to enable a user to selectively screw a portion of socket cover 10 into or out of socket 20. In one embodiment, head 12 includes a domed head to spread moisture or precipitation from socket 20.

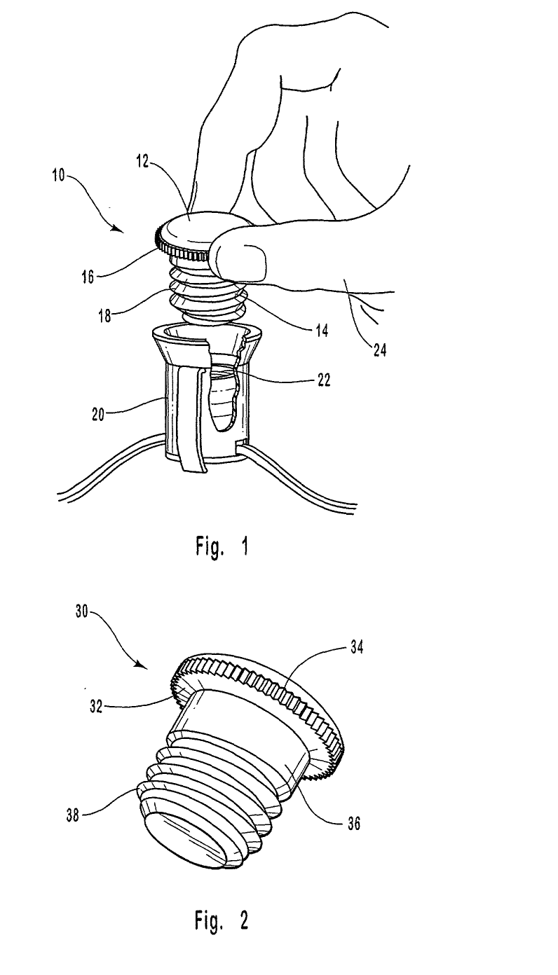

With reference now to FIG. 2, an embodiment is illustrated that allows for a portion of a lamp socket cover to be threadedly coupled to a socket. As with lamp socket cover 10 of FIG. 1, lamp socket cover 30 of FIG. 2 includes a head 32 coupled to a shaft 36, wherein the head includes a grip 34 and the shaft includes threads 38. Threads 38 correspond to threads of a socket (not shown) for which lamp socket cover 30 may be received.

In FIG. 2, lamp socket cover 30 comprises a unitary body design that provides a simple, safe affordable and flexible manner for customizing a light set or strand of any length to the desires of the user. Lamp socket cover 30 includes threads 38 to enable cover 30 to be screwed into or out of a lamp socket. Furthermore, cover 30 provides a covering to a corresponding lamp socket to prevent personal injury or property damage as a result of an exposed lamp socket. In one embodiment the color of cover 30 corresponds to the color of the light strand so as to blend in with the light strand and enhance the overall appeal.

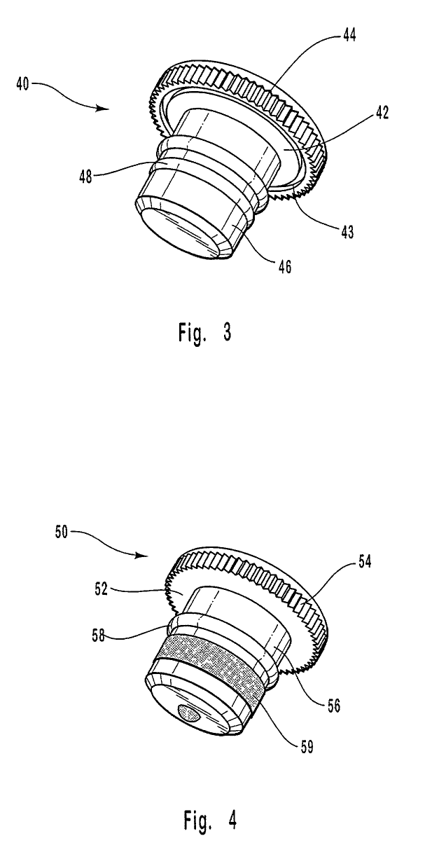

With reference to FIG. 3, another embodiment of the present invention is illustrated as lamp socket cover 40, which includes head 42 and shaft 46. Head 42 comprises a grip 44 and is coupled to a top end of shaft 46. Furthermore, head 42 includes a channel 43 that corresponds to an upper rim of a lamp socket when cover 42 is coupled to a lamp socket. In one embodiment, shaft 46 provides a smooth surface and is tapered. As such, cover 40 is inserted into a lamp socket by being pushed into the lamp socket aperture. As illustrated in FIG. 3, embodiments of the present invention embrace the coupling of an outer rim of the socket to a channel, such as channel 43, to enable the coupling of cover 40 with the lamp socket.

In another embodiment, channel 43 is not included in head 42. Thus, when lamp socket cover 40 is pushed into a lamp socket, the friction caused by the outer wall of shaft 46 against the inner wall of the lamp socket maintains the lamp socket cover in position. In yet another embodiment, and as illustrated in FIG. 3, shaft 46 includes a coupling mechanism 48. An example of a coupling mechanism includes a raised surface to enable friction against an interior wall of a lamp socket.

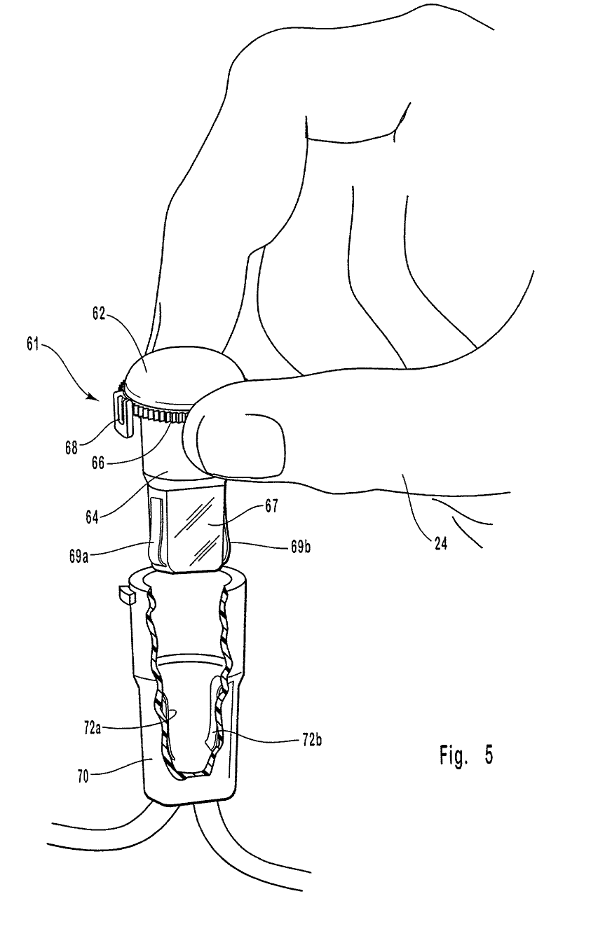

With reference now to FIG. 4, another embodiment of the present invention is illustrated as lamp socket cover 50 and includes head 52 and shaft 56. Head 52 includes a grip 54 and shaft 56 includes a conductor 59 that comprises a conductive material, such as a metal or another conductive material, to enable the flow of current between contact points of a lamp socket for which cover 50 is inserted.

Those skilled in the art will appreciate that conductor 59 may include a variety of configurations. For example, one configuration includes the use of a conductive material throughout shaft 56. Another example of the configuration of the conductor is illustrated as conductor 59 in FIG. 4, which includes a band or portion of shaft 56 that extends around the outer surface of shaft 56 to enable contact from a first electrical contact to a second electrical contact of a lamp socket. Another configuration includes a portion or strip of conductive material that extends axially down the shaft, as illustrated in FIG. 5.

With reference now to FIG. 5, an illustration is provided of another representative system that prevents the exposure of an otherwise unused lamp socket. In FIG. 5, lamp socket cover 61 is configured to selectively couple with lamp socket 70, which is a lamp socket of a light strand that is unused or from which illumination is not desired. In one embodiment, lamp socket 70 is part of a light strand that is configured for use indoors and/or for use with lamps that are pushed into lamp socket 70. Lamp socket cover 61 includes head 62, which optionally includes grip 66, which is coupled to shaft 64. Furthermore, in the illustrated embodiment, head 12 includes connector 68, which is configured to be selectively coupled to a protrusion of socket 70 to maintain at least a portion 67 of shaft 64 in socket 70. In one embodiment, when cover 61 is inserted into socket 70 by a user 24, electrical contacts 69 of socket cover 61 connect to corresponding electrical contacts 72 to close the electrical circuit. As such, a strand of lights that is wired in series may still illuminate when one or more socket covers are selectively coupled to the strand for decoration purposes or otherwise.

Thus, as discussed herein, embodiments of the present invention embrace systems and methods for selectively covering a socket that is configured to receive a light source. The present invention may be embodied in other specific forms without departing from its spirit or essential characteristic. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. An apparatus configured to selectively cover a lamp socket and does not include a light source, the apparatus comprising:
means configured for selective insertion into the lamp socket, wherein the means for inserting includes a top and a bottom;
means for gripping coupled to the top of the means for selective insertion, and wherein at least one of (i) the means for selective insertion and (ii) the means for gripping includes means for selectively coupling the apparatus to the lamp socket.

2. An apparatus as recited in claim 1, wherein the means for selective insertion comprises a non-conductive material.

3. An apparatus as recited in claim 2, wherein the means for selective insertion comprise a conductive material.

4. An apparatus as recited in claim 2, wherein the non-conductive material comprises at least one of:
(i) a polymer; and
(ii) a rubber material.

5. An apparatus as recited in claim 4, wherein the polymer comprises at least one of:
(i) polypropylene; and
(ii) polyethylene.

6. An apparatus as recited in claim 5, wherein the polyethylene comprises at least one of:
(i) high density polyethylene; and
(ii) polyethylene terephthalate.

7. An apparatus as recited in claim 5, wherein the rubber material comprises a pliable rubber.

8. An apparatus as recited in claim 1, wherein the means for gripping comprises at lease one of:
(i) a roughened surface;
(ii) a raised surface;
(iii) an aperture; and
(iv) a groove.

9. An apparatus as recited in claim 1, wherein the means for selectively coupling comprises at lease one of:
(i) friction;
(ii) a raised surface;
(iii) a threaded surface; and
(iv) a detent mechanism.

10. A lamp socket cover comprising:
a shaft configured for selective insertion of at least a portion of the shaft into a lamp socket, the shaft having a diameter, and wherein the shaft includes a top and a bottom;
a head coupled to the top of the shaft, and wherein at least one of (i) the shaft and (ii) the head includes a coupling mechanism to selectively couple the lamp socket cover to the lamp socket.

11. A lamp socket cover as recited in claim 10, wherein the shaft comprises a conductive material.

12. A lamp socket cover as recited in claim 10, wherein the shaft comprises a non-conductive material.

13. A lamp socket cover as recited in claim 12, wherein the coupling mechanism comprises a channel located in the head that is configured to receive a rim of the lamp socket.

14. A lamp socket cover as recited in claim 12, wherein the coupling mechanism comprises at least one of:
(i) friction;
(ii) a threaded surface;
(iii) a raised surface;
(iv) a detent mechanism.

15. A lamp socket cover as recited in claim 12, wherein the head is domed.

16. A lamp socket cover as recited in claim 10, wherein the coupling mechanism prevents moisture from entering into the lamp socket.

17. A method for selectively covering a lamp socket, the method comprising the steps for:
providing a lamp socket that is configured to selectively receive a lamp;
providing a lamp socket cover that includes a shaft and a head; and
selectively coupling at least a portion of the lamp socket cover to the lamp socket.

18. A method as recited in claim 17, further comprising the step for using the lamp socket cover to prevent moisture from entering into the lamp socket.

19. A method as recited in claim 17, wherein the step for selectively coupling at least a portion of the lamp socket cover to the lamp socket comprises the step for inserting at least a portion of the lamp socket cover into the lamp socket, wherein the step for inserting comprises at least one of the steps for:
(i) pushing a portion of the lamp socket cover into a portion of the lamp socket; and
(ii) screwing a portion of the lamp socket cover into the portion of the lamp socket.

20. A method as recited in claim 17, wherein the step for providing the lamp socket cover includes the step for providing the lamp socket cover having a color corresponding to a color of the lamp socket.
